(19) United States
(12) Patent Application Publication
(10) Pub. No.: US 2013/0330444 A1
(43) Pub. Date: Dec. 12, 2013

(54) MOLDABLE PROTEIN MATRIX CONTAINING FRUIT, VEGETABLES, CHOCOLATE OR COCOA, FOR FOOD APPLICATIONS, AND PROCESS FOR ITS MANUFACTURE

(71) Applicants: Claudia Marina Barbosa Senra Lopes, Barcelos (PT); Domingos Paulo Ferreira De Almeida, Porto (PT)

(72) Inventors: Claudia Marina Barbosa Senra Lopes, Barcelos (PT); Domingos Paulo Ferreira De Almeida, Porto (PT)

(21) Appl. No.: 13/979,488

(22) PCT Filed: Jan. 10, 2012
(86) PCT No.: PCT/PT2012/000001

§ 371 Date: Aug. 16, 2013

(30) Foreign Application Priority Data
Jan. 13, 2011 (PT) 105482

(51) Int. Cl. A23L 1/16

(52) U.S. Cl. CPC A23L 1/16
USPC 426/104; 426/615; 426/640; 426/631

(57) ABSTRACT

The present invention relates to a formulation of a moldable protein matrix which after drying has a high concentration (from 60% to 90%) of fruits, vegetables, chocolate or cocoa. It also allows for the incorporation of flavors and coloring agents in order to obtain a product that is very similar, both in texture and taste, to fruit, chocolate or cocoa. It may be used, directly or by incorporation, in different kind of food, such as ice creams, pastries and dairy products. The invention refers also to the process for the manufacture of products based on this matrix with a texture and taste similar of the fruit, vegetables and cocoa.

### FIELD OF THE INVENTION

The present invention describes a new product for the food industry, which can be consumed directly or applied to various kinds of processed products including dairy, ice creams and pastry. This new product is a protein matrix, containing mostly fruit, vegetables, chocolate and cocoa, and can optionally contain coloring and flavoring agents in order to increase the perception of the included fruits, vegetables, chocolate or cocoa. It can be molded into different shapes and, after preparation, can be incorporated in assembled food products.

### BACKGROUND OF THE INVENTION

Shaping fruit matrices into artificial shapes has been addressed by different means. The applicant of this patent request has a previous patent which on spheres of fruit and/or vegetables, prepared for application in the food industry, with a diameter between 2 and 5 mm and constituted by an hydrocolloids matrix, fruit and/or vegetables (Portuguese patent PT103529).

Another patent associated to the shaping of fruit matrices uses polysaccharides to form of a bar (Portuguese patent application PT 104449).

In addition, Portuguese patent application PT 104978 refers also to dehydrated fruit with different shapes for human consumption.

The present invention resorts to the viscoelastic properties of certain proteins to shape food matrices with high content of fruit, vegetables, cocoa, or chocolate, in such as way that the final product is perceived as the fruit, vegetable, cocoa or chocolate molded into an artificial shape.

Several ingredients, such as vegetables, aromatic herbs, microalgae, dietary fiber, B-carotene, inulin, and others, have been added to pasta to change its nutritional compositions (Brennan et al., 2004; Nielsen et al., 1980; Pereria et al., 1999). These improvements of pasta have been done with the addition of 15% of vegetables and aromatic herbs, such as basil, coriander, tarragon, spinach, garlic and onion (U.S. Pat. No. 4,517,215; U.S. Pat. No. 5,508,053; patent application US 2004/0146629 A1; patent application EP 0705541 A1).

The present invention demonstrates that protein matrices of gluten or glutenin can retain very high amounts (60% and 90%) of fruit, vegetables, chocolate and cocoa, while maintaining an integrity and physical characteristics that allow shaping and subsequent processing, which are very important for this application. So, it provides a way to format fruit, vegetables, chocolate and cocoa without the use of gelling agents, as mentioned in the background of the invention.

The improvement of pasta with dietary fibers increases its functional value (U.S. Pat. No. 4,976,982; patent application US 2004/0224068 A1; patent application EP 0412639 A2). For instance, the addition of plant sterols that promotes the reduction of LDL (patent application U.S. 2005/0019470 A1). The addition of algae as Chorella vulgaris and Spirulina maxima (from 0.5 to 2.0%) allows an increase in tensile strength of the pasta, change of its color and the a nutritional improvement due to their antioxidant properties (Fradique et al., 2010). The algae Undaria pinnatifida was also added to the pasta (Prabhasankar et al., 2009).

The addition of fruit or vegetable ingredients to durum wheat semolina at concentrations above 35% makes it very difficult to mold the matrix into a shape stable for subsequent processing. Levels of other ingredients above 35% increase the cooking losses, reduce cohesiveness and increases fractures to unacceptable levels (Wood, 2009). The introduction of vegetable flour dilutes the gluten and weakens the protein network responsible for leaching of more solids in the cooking water (Petitot et al., 2010).

Therefore, few attempts have been made to enrich pasta with fruit, and the ones that have been made demonstrate incorporation of low concentrations of fruit. The incorporation of mango peel powder up to 7.5%, allowed an increase on dietary fiber content, as well as on polyphenols and carotenoids, which leads to an improvement of the nutritional quality and nutraceutional properties of pasta without significantly affecting the physical and sensorial properties (Ajila et al., 2010). With the addition of banana flour up to 45%, the pasta increases the rate of carbohydrate non-digestible resistant starch and non-starch polysaccharides and antioxidants (Ovando-Martinez et al. 2009).

None of the pasta formulations described above provides for the application of high levels of fruit, vegetables, chocolate or cocoa (60 to 90% by weight after drying) or for the application in accordance with the invention.

### BRIEF DESCRIPTION OF THE FIGURES

FIG. 1 represents a diagram of the process of preparing the protein matrix, which is the object of this invention.

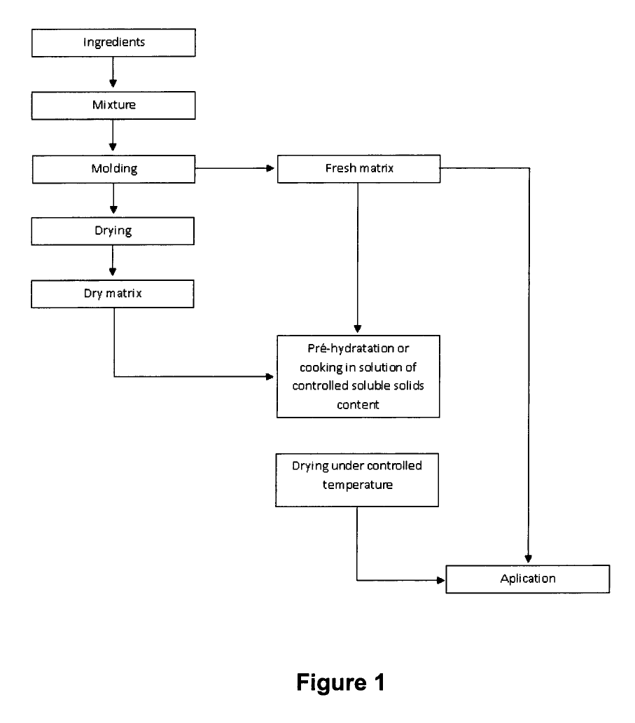

FIG. 2 is a photograph of a products made of strawberry (A), banana (B), apricot (C) and kiwi (D) molded from the protein matrix according to example 1.

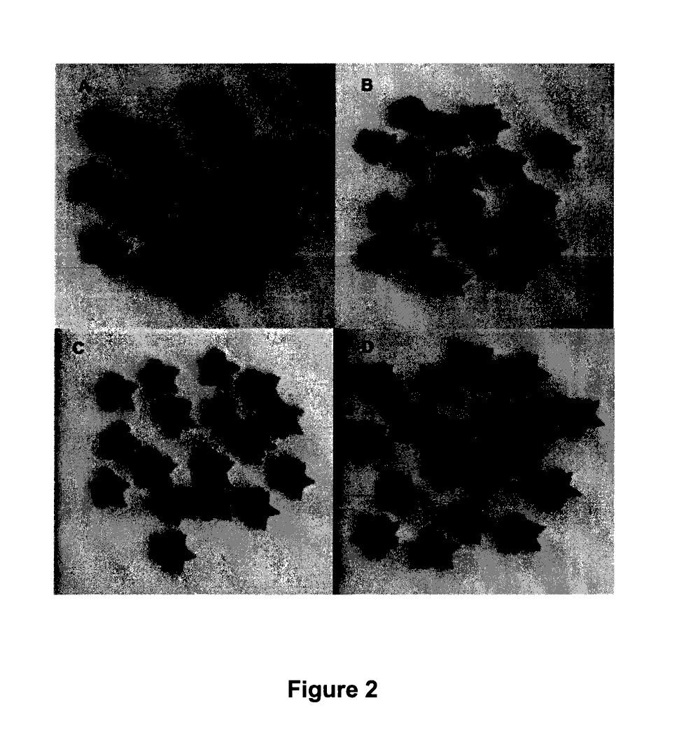

### SUMMARY OF THE INVENTION

The present invention describes a protein matrix containing fruit, vegetables, chocolate or cocoa, which is moldable into an artificial shape, for direct consumption or incorporation after preparation into other food products, such as dairy, pastry and ice cream. More specifically, it refers to the use of the viscoelastic properties of a protein matrix to format the fruit, vegetables, chocolate or cocoa incorporated into the formulation. That formulation can be molded in different shapes and, can be directly consumed or undergo secondary treatments that allow an replication of the flavor and texture of the fruit, vegetable, cocoa or chocolate used as ingredient, for use in other food products, namely dairy products, pastry and ice cream.

### DETAILED DESCRIPTION OF THE INVENTION

The present invention creates a new technological platform for the development of new food products and opens a new field of applications in food industry. The invention described herein consists of a protein matrix that after drying contains 60 to 90% of fruits, vegetables, chocolate or cocoa, and can be molded into artificial shapes. The disclosed invention provides nutritional benefits by direct ingestion or by incorporation in different kind of foods, such as ice-cream, pastry and dairy products. In addition, the new protein matrix, based on fruits, vegetables, chocolate or cocoa, allows the development of a new range of food product. The present invention also provides a solution of the technical problem associated with thermal treatment of chocolate and cocoa by allowing pasteurization and sterilization without melting. Furthermore, the organoleptic properties and physical integrity of the pieces, nuggets and different shapes of chocolate can be kept stable after processing.

The protein matrix disclosed herein can be constituted of gluten or glutenin, either purified or present in semolina and cereal flours. The amount of fruits, vegetables, chocolate or cocoa ranges from 60% to 90% of total dried product. Thus, the protein matrices emerge as a technologic adjuvant that allows not only the molding and shaping of the main ingredients, but also provides stability during and after pasteurization without damaging its initial form. Although the protein matrix with low content of vegetables, typically less than 15%, has been eaten cooked as pasta, the application of the matrix has not been previously described in novel ice-creams, pastry and dairy products containing artificial shapes of fruit, vegetables, cocoa or chocolate. Also, the results of this application were not expected based on the state of the art.

The described invention is analogue to the production of pasta, but goes beyond the state of the art in pasta technology, formulation, and applications, not only because it incorporates very high doses of fruits, vegetables, chocolate or cocoa but is also able to confer flavor and texture similar to that of fruit, vegetables, chocolate or cocoa. Furthermore, the resulting products, including the artificially shaped fruit pieces, vegetables and chocolate nuggets, can be incorporated in food products, such as ice-creams, pastry and dairy products and not be perceived as pasta.

The present invention refers to fruit, vegetables, chocolate and cocoa that are supported by a moldable protein matrix in different formats for direct consumption or subjected to treatment to improve flavor and texture with subsequent incorporation in other foods, in particular dairy, pastry and ice-cream products.

The protein matrix formulation containing fruit, vegetables, chocolate or cocoa, uses the viscoelastic properties of a protein network, composed by gluten or glutenin, either purified or present in semolina and flour of cereals, to retain and to format the main ingredients. In addition to fruits, vegetables, chocolate and cocoa, the protein matrix formulation can also contain colorants and flavors to improve the perception regarding the flavor and color of fruit, vegetables, chocolate and cocoa.

The protein matrix formulation, containing fruit, vegetables, chocolate or cocoa, is prepared by application of processes that are traditionally used in the production of either fresh or dried pasta, without extrusion step. The molding can include many shapes, such as spheres, cubes, parallelepipeds, stars, letters, and animals.

The shaped products obtained from the protein matrix formulation can be eaten directly either by cooking or by incorporation into other foods, including dairy, pastry and ice-creams.

More specifically, the first object of this invention are moldable protein matrices for using in food industry, either fresh or dried, which can be cooked and consumed in the same way as alimentary pasta or be prepared for later addition to other processed foods, which comprise:
a) one main food ingredient select from fruit vegetables, cocoa, or chocolate;
b) a protein component selected from durum wheat semolina, wheat flour, rice flour, gluten and glutenin;
c) water;
d) optionally flavors and coloring agents;
   in which the percentage by weight of main food ingredient after drying is between 60% and 90%.

The percentage by weight of main food ingredient after drying is preferably between 75 and 85%.

Durum wheat semolina, soft wheat flour and rice flour can be present in amounts that go from 10% to 40% of weight, after drying. In the event of use of gluten or glutenin the amount of protein may be lower than 1.5% of weight, after drying. This quantity is sufficient to support the fruit, vegetables, cocoa or chocolate used as main food ingredient.

The matrix can be molded and formatted in different shapes, such as spheres, cubes, parallelepipeds, stars, letters or other shapes drawn specifically for the purpose.

The main food ingredient, in case of fruit or vegetables, can be present in form of dehydrated powder, polme, purée, pulp, juice and juice concentrated.

If cocoa is the main food ingredient, the preferred form is a powder.

Eggs, salt, dietetic fibers, vitamins and proteins can be optionally used as food ingredients.

Aromas and dyes, if present, can occur either as powder or in the liquid state.

The preparation of the protein matrix herein described is carried out in agreement with the processes used for pasta, either fresh or dried. The two main steps are:
1) mixture of wheat semolina or cereal flour or gluten or glutenin with main food ingredient until there is a homogenous mixture; next, the aromas and dyes are mixed, and then a moldable paste is obtained by adding water; and
2) kneading, shaping or molding wherein the moldable matrix appears in different standard shapes, e.g. stars and letters, or other different shapes drawn for a specific purpose.

The matrix manufacturing can be ended by this stage or it can be dried to final humidity values within 5 to 15%.

The process of manufacture of protein matrices described above constitutes a second object of the invention, which comprises:
a) mixing the ingredients;
b) kneading, shaping or molding the pasta in order to obtain different shapes;
c) optionally drying;
d) and optionally cooking in solution with controlled brix (between 30 and 60%) followed by drying at controlled temperature.

Preferably, the described process is about the mixture of the protein component with the main food ingredient, in order to obtain a homogeneous mixture wherein aroma, dye and water are after added to prepare a final paste. This paste should have a humidity level within 25-32%; molding and shaping are used in a similar fashion to pasta. The moldable matrix can be molded either in standard shapes or in new shapes drawn for specific applications; and optionally, the humidity level can be lowered to 5-15% by drying.

The disclosed matrix, fresh or dried, can be cooked and consumed in a similar fashion to pasta. Also, the matrix can be prepared to be added to other foods, by cooking in controlled solutions with controlled soluble solids content, between 30 and 60%, and then by drying at controlled temperature to obtain the desirable end texture to simulate fruit, vegetable of chocolate. This process may be employed in the preparation of shaped matrices for applications in industrial ice-cream, yoghurt, or pastry products.

The invention will be described in the examples not limited the following:

### Example 1

### Obtaining Protein Matrices with Fruit in the Form of Powder

Composition (in percentage of initial weight of the ingredients):

| | |
|---|---|
| Dehydrated fruit in form of powder | 60.60% |
| Water | 24.24% |
| Durum wheat semolina | 14.80% |
| Flavor | 0.36% |

### Example 2

### Obtaining Protein Matrix with Fruit Pulp

Composition (in percentage of initial weight of the ingredients):

| | |
|---|---|
| Durum wheat semolina | 31% |
| Pulp fruit concentrated | 60% |
| Water | 9% |

### Example 3

### Obtaining Protein Matrix with Cocoa

Composition (in percentage of initial weight of the ingredients):

| | |
|---|---|
| Cocoa | 60.40% |
| Water | 24.15% |
| Durum wheat semolina | 15.09% |
| Flavor | 0.36% |

### Example 4

### Obtaining Protein Matrix with Strawberry in Form of Powder and Gluten

Composition (in percentage of initial weight of the ingredients):

| | |
|---|---|
| Strawberry dehydrated in form of powder | 74.60% |
| Water | 23.90% |
| Gluten in form of powder | 1.50% |

The semolina of the durum wheat is mixed with fruit in the different form (powder dehydrated in example 1 or pulp fruit concentrated in example 2) or with cocoa (example 3) to obtain a homogeneous mixture. Then, the flavor is added to integrate it into the mix and then the water to obtain moldable pasta. The moisture content of this moldable pasta is approximately 25-32%.

In the case of strawberry powder matrix and gluten (example 4), the gluten is dissolved in water at 80° C. and then the strawberry powder is added, blending in order to obtain a homogeneous mixture.

After, the pasta is molded into shapes of pasta (e.g. stars, letters) or news shapes specifically designed for certain applications (e.g. stars to apply in yogurt).

The resulting product can be directly consumed or it can go through a drying process until its moisture content is of approximately 12%. The dry matrices are cooked in a solution with a controlled soluble solids content (e.g. sucrose or other sugars), between 30 to 60%, during 1 to 5 minutes, in order to allow the development of the final texture to simulate that of the fruit, vegetable or chocolate.

### REFERENCES

Ajila, C. M., Aalami, M., Leelavathi, K., & Prasada Rao, U. J. S. (2010). Mango peel powder: A potential source of antioxidant and dietary fiber in macaroni preparations. Innovative Food Science and Emerging Technologies, 11, 219-224.
Brennan, C. S., Kuri, V., & Tudorica, C. M. (2004). Inulin-enriched pasta: Effects on textural properties and starch degradation. Food Chemistry, 86, 189-193
Fradique, M., Batista, A. P., Nunes, M. C., Gouveia, L., Bandarra, N. M. & Raymundo A. (2010). Incorporation of Chlorella vulgaris and Spirulina maxima biomass in pasta products. Part 1: Preparation and evaluation. Journal of the Science of Food and Agriculture, 90, 1656-1664.
Nielsen, M. A., Summer, A. K., & Whalley, L. L. (1980). Fortification of macaroni with pea flours and air classified pea protein concentrates. Cereal Chemistry, 57, 203-206.
Ovando-Martinez, M., Sayago-Ayerdi, S., Agama-Acevedo, E., Goñib, I. & Bello-Pereza, L. A. (2009). Unripe banana flour as an ingredient to increase the undigestible carbohydrates of pasta. Food Chemistry, 113, 121-126.
Pereria, M. R., Amaya-Farfan, J., & Rodriguez-Amaya, D. (1999). Carotene content of Brazilian fortified macaroni. Food Chemistry, 10, 81-85.
Petitot, M., Boyer, L., Minier, C., & Micard, V. (2010). Fortification of pasta with split pea and faba bean flours. Pasta processing and quality evaluation. Food Research International, 43, 634-641.
Prabhasankar, P., Ganesan, P., Bhaskar, N., Hirose, A., Stephen, N., Gowda, L. R., Hosokawa, M., & Miyashita, K (2009). Edible Japanese seaweed, wakame (Undaria pinnatifida) as an ingredient in pasta: Chemical, functional and structural evaluation. Food Chemistry, 115, 501-508.
Wood, J. A. (2009). Texture, processing and organoleptic properties of chickpea fortified spaghetti with insights to the underlying mechanisms of traditional durum pasta quality. Journal of Cereal Science, 49, 128-133.
U.S. Pat. No. 4,517,215;
U.S. Pat. No. 5,508,053;
Patent application US 2004/0146629 A1;
Patent application EP 0705541 A1
U.S. Pat. No. 4,976,982;
Patent application US 2004/0224068 A1;
Patent application EP 0412639 A2
Patent application US 2005/0019470 A1
Portuguese patent PT 103529
Portuguese patent application PT 104449
Portuguese patent application PT 104978

1. A Moldable protein matrix for using in food industry, either fresh or dried, which can be cooked and consumed in the same way as alimentary pasta or be prepared for later addition to other processed foods, which comprise:
a) a main food ingredient selected from the group consisting of fruit, vegetables, cocoa, and chocolate;
b) a protein component selected from the group consisting of durum wheat semolina, wheat flour, rice flour, gluten and glutenin;
c) water; and
d) optional flavors and coloring agents;
in which the percentage by weight of main food ingredient after drying is between 60% and 90%.

2. The protein matrix according to claim 1, wherein the percentage by weight of main food ingredient, after drying, is between 75% and 85%.

3. The protein matrix according to claim 1, wherein they have a shape selected from spheres, cubes, parallelepipeds, stars, letters, figures, animals and the like.

4. The protein matrix according to claim 1, wherein the main food ingredient is fruit or vegetables and is in form of dehydrated powder, polme, polpe, purée or juice and their concentrates.

5. The protein matrix according to claim 1, wherein the main food ingredient is cocoa or chocolate and is in the form of powder.

6. A Process for the manufacture of the protein matrix according to claim 1, comprising:
a) mixing the ingredients to form a pasta mixture;
b) kneading, shaping or molding the pasta mixture in order to obtain different shapes;
c) optionally drying; and
d) optionally cooking in solution with controlled brix (between 30 and 60%) followed by drying at controlled temperature.

7. The Process according to claim 6, which further comprises:
mixing the protein component with the main food ingredient, to obtain a homogeneous mixture and optionally adding flavoring and coloring additives;
adding water to bind the pasta mixture, such that the moisture content of this pasta is 25%-32%;
molding or shaping into standard shapes of pasta or new forms specifically designed for certain applications; and
optionally, drying until the moisture content reaches a value of 5-15%.
